(19) United States
(12) Patent Application Publication
(10) Pub. No.: US 2018/0025712 A1
(43) Pub. Date: Jan. 25, 2018

(54) Keyboard for an Electronic Musical Instrument

(71) Applicant: Alpha Pianos GmbH, Andra-Wordern (AT)

(72) Inventor: Mario Aiwasian, Kierling (AT)

(21) Appl. No.: 15/642,488

(22) Filed: Jul. 6, 2017

(30) Foreign Application Priority Data
Jul. 25, 2016 (EP) 16180995.9

(51) Int. Cl. G10H 1/34

(52) U.S. Cl. CPC G10H 1/344; G10H 2220/275; G10H 2220/461

(57) ABSTRACT

A keyboard for an electronic musical instrument, comprising a keybed with a multitude of keys supported therein and comprising a multitude of hammer heads supported on the keybed, which hammer heads can each be driven by a respective key by means of a mechanism, wherein, in the keybed, each hammer head is arranged opposite a resilient tongue which is fixed at its root so as to be struck by the hammer head when the key is actuated, and wherein the tongue is equipped with an impact sensor, wherein, on the side of the tongue facing away from the hammer head, a stop for the tongue is mounted on the keybed at a distance from the tongue, wherein a resilient vibration damper lies at least in the region of the root of the tongue between the tongue and the stop.

### CROSS-REFERENCE TO RELATED APPLICATION(S)

This application claims priority to European Patent Application No. 16 180 995.9, filed Jul. 25, 2016, the disclosure of which is herein incorporated by reference in its entirety.

### FIELD OF THE INVENTION

The present application relates to a keyboard for an electronic musical instrument, comprising a keybed with a multitude of keys supported therein and comprising a multitude of hammer heads supported on the keybed, which hammer heads can each be driven by a respective key by means of a mechanism, wherein, in the keybed, each hammer head is arranged opposite a resilient tongue which is fixed at its root so as to be struck by the hammer head when the key is actuated, and wherein the tongue is equipped with an impact sensor.

### BACKGROUND

A keyboard of this type is known from AT 508.620 B1 and combines the response and playing behaviour of a conventional grand piano or upright piano hammer mechanism with the possibilities of controlling an electronic musical instrument by means of the impact sensors. The tongues are milled out from a printed circuit board in a projecting manner. The impact sensors are strain gauges applied to the printed circuit board, which strain gauges measure the resilient deflection of the tongues when these are struck by the hammers and convert this into control signals for the musical instrument.

### SUMMARY

The objective of the present application is to further improve a keyboard of this type in respect of authenticity and playability.

This objective is achieved with a keyboard of the type mentioned in the introduction, wherein, on the side of the tongue facing away from the hammer head, a stop for the tongue is mounted on the keybed at a distance from the tongue, wherein a resilient vibration damper lies at least in the region of the root of the tongue between the tongue and the stop.

The construction according to the application formed of tongue, vibration damper and stop on the one hand results in a reduction of the maximum deflection of the tongue, even when the keys are struck hard, which prevents microcracks in the tongues and contributes to a longer service life of the keyboard, and on the other hand the response behaviour of the tongue can be sensitively adapted to the desired impact behaviour of the keyboard due to the vibration damper located between the stop plate and tongue.

A spring element, a pneumatic or hydraulic damping element, or the like can be used as vibration damper. The vibration damper is in some embodiments a lip made of resilient material, for example made out of rubber or silicone, which enables a space-saving sandwich construction of tongue, vibration damper and stop plate.

In accordance with an optional feature, the tongue is approximately trapezoidal and the lip is narrower than the tongue. This allows the edges of the tongue to vibrate freely, which contributes to a natural feel when playing the instrument, similarly to the striking of a vibrating string.

For the same reason, it is particularly favourable if the lip of the tongue, as considered from the root, ends before the region of the tongue that is provided for the striking of the hammer head. This allows the impact region of the tongue to vibrate freely, which makes it possible to recreate the feel of striking a vibrating string to the best possible extent.

The production and assembly of a keyboard having a multitude of keys, for example 88 or 97 keys as in the case of a large concert grand piano can be simplified if the lips of a plurality of keys arranged adjacently in the keybed are formed from a common sheet of resilient material, protruding therefrom in a comb-like manner. At the time of assembly, the common lip sheet, for example for one or more octaves of the keyboard, can be assembled in a single step.

In accordance with another optional feature, the lip of the tongue for a key that is associated with a higher tone of the musical instrument is longer than the lip of the tongue for a key that is associated with a lower tone of the musical instrument. Alternatively or additionally, the tongue of a key that is associated with a higher tone of the musical instrument can be shorter than the tongue for a key that is associated with a lower tone of the musical instrument. Lastly, also alternatively or additionally, the hammer head of a key that is associated with a higher tone of the musical instrument can also strike against its tongue closer to the root than the hammer head of a key that is associated with a lower tone of the musical instrument. All of these measures enable a fine adjustment of the impact behaviour of the keyboard in such a way that the striking of a high tone is perceived to be harder than the striking of a low tone, as corresponds to the striking of strings of an acoustic grand piano or upright piano.

In order to simplify the manufacture, it is possible, as is known per se from AT 508.620 B1, to form the tongues of a plurality of keys arranged adjacently in the keybed from a common printed circuit board, protruding therefrom in a comb-like manner. Manufacture can be simplified further if the stop is a joint stop plate for all tongues. The stop plate can in this way be assembled in a single step, whether for one, more or all octaves of the keyboard.

The printed circuit board is in some embodiments screwed or bolted to the stop plate in the region from which the tongues protrude, with the vibration damper being arranged in-between. This yields a stable sandwich structure with a long life span.

In a further embodiment, the region of the tongue that is provided for the striking of the hammer head has a hole that is smaller than the impact face of the hammer head. Air can thus escape quickly between the hammer head and tongue when the hammer head strikes, which minimises the noise produced by the keyboard on account of the striking process.

The impact sensor on the spring tongue can be of any type known per se in the art, for example an acoustic sensor, an acceleration and shock sensor, optical or electromagnetic sensor, a force sensor, etc. The impact sensor, as is known per se from AT 508.620 B1, is constituted by at least one strain gauge applied to the tongue. Such a strain gauge is very thin and can, for example be applied directly in the form of corresponding resistor pastes to the printed circuit board and is optionally contacted even by the printed circuit board itself, i.e. by means of corresponding conductors thereof.

### BRIEF DESCRIPTION OF THE DRAWINGS

The present application will be explained in greater detail hereinafter on the basis of an exemplary embodiment illustrated in the accompanying drawings, in which

FIG. 1 shows a section through a keyboard in the region of a key;

FIG. 2 shows a view from below of an assembly formed of tongue, vibration damper and stop of the keyboard of FIG. 1; and

FIGS. 3a to 3c show plan views of a printed circuit board with tongues (FIG. 3a), a sheet with lips (FIG. 3b), and a stop plate (FIG. 3c) of the keyboard of FIG. 1.

### DETAILED DESCRIPTION OF THE DRAWINGS

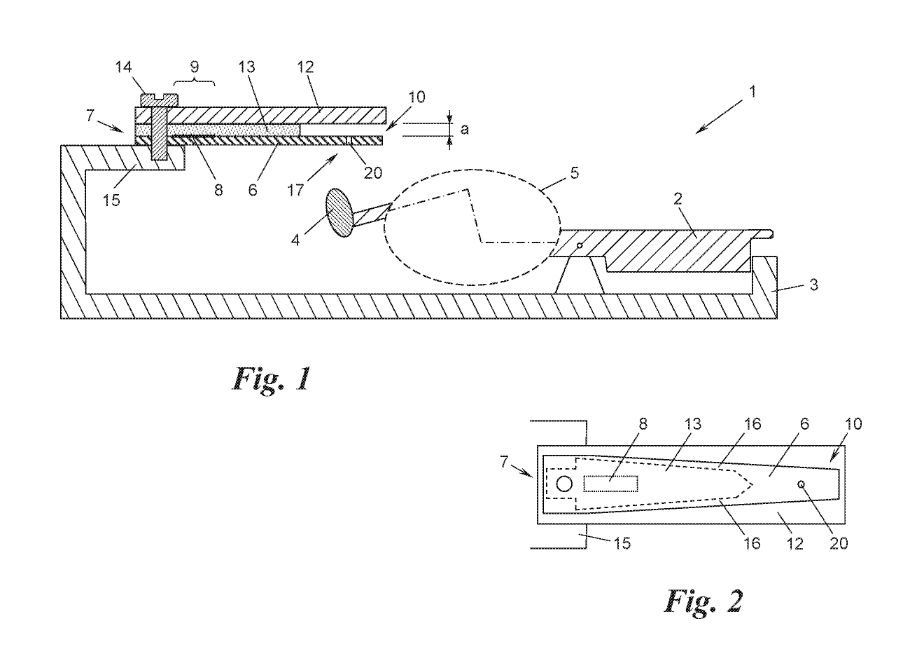

FIG. 1 shows a keyboard 1 for an electronic musical instrument (not illustrated in greater detail), for example an electronic keyboard, an electronic organ, or a synthesiser. Only a single key 2 of the keyboard 1 has been shown, with the components associated with said key and described further below; it goes without saying that the keyboard 1 comprises a multitude of keys 2 arranged adjacently in the plan view, for example 88 or 97 keys 2 in a number of octaves in the case of a concert grand piano construction.

The keys 2 of the keyboard 1 are mounted in a keybed 3 in the manner of two-armed levers, as well as hammer heads 4, wherein each hammer head 4 can be driven by means of a conventional keyboard mechanism 5 of a corresponding key 2 (not illustrated here in detail), such that, as a key 2 is pressed or struck, the hammer head 4 is thrown upwardly as in the case of a conventional grand piano or is thrown forward as is the case in an upright piano.

Instead of a string, as is the case in a grand piano or upright piano, a resilient tongue 6 is arranged opposite the hammer head 4 and is fixed at its root 7 in the keybed 3 and can thus be struck by the hammer head 4 when the key 2 is actuated—similarly to a string. The tongue 6 is equipped with an impact sensor 8, which detects the striking of the tongue 6, and in so doing optionally also measures the strength of the impact and converts this into a control signal for the electronic musical instrument.

The impact sensor 8 can be a switch, an electromagnetic, optical or acoustic sensor, or the like. The impact sensor 8 is in some embodiments formed by at least one or more strain gauges applied to the tongue 6, which strain gauge(s) is/are applied to the tongue 6 in particular in the region of the root 7 of the tongue. In the root region 9, the strain gauge thus measures the resilient deflection of the protruding end 10 of the tongue 6 on the basis of the deflection of the tongue 6 in the root region 9.

The tongue 6 is made of a resilient material, for example is made of a spring metal, a resilient plastic, or optionally a printed circuit board piece (PCB for short), to which the impact sensor 8, for example even as a strain gauge, is applied in the form of a resistor paste and is contacted by the conductors of the printed circuit board.

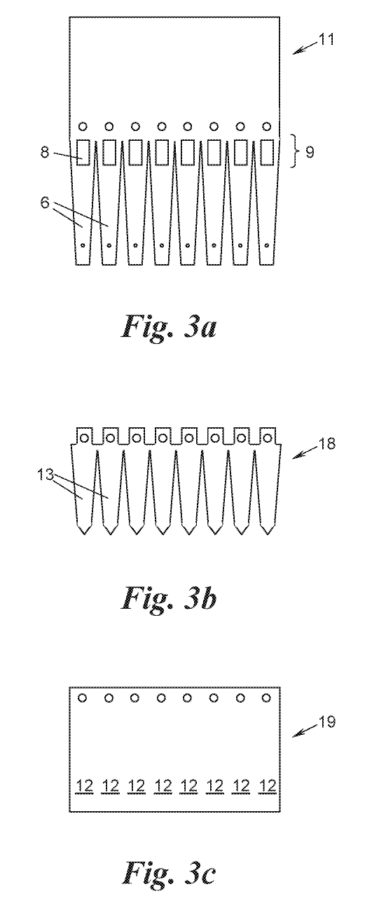

As shown in FIG. 2, the tongue 6 for each key 2 can be a separate element associated separately with this key 2, for example a strip of printed circuit board material. However, the tongues 6 of a plurality of keys 2 arranged adjacently in the keyboard 1 are in some embodiments formed from a common printed circuit board 11, protruding therefrom in a comb-like manner, for example by milling or punching the printed circuit board 11; see FIG. 3a.

A stop 12 is mounted on the keybed 3 on the side of each tongue 6 facing away from the hammer head 4 and at a distance a from the tongue 6 or protruding end 10 thereof. The stop 12 prevents an excessive deflection of the tongue 6 when this is struck by the hammer 4, and thus prevents microcracks in the tongue 6, these possibly being detrimental to the service life of the keyboard 1.

At the same time, a resilient vibration damper 13 is arranged between the tongue 6 and stop 12. The resilient vibration damper 13 can be a spring acting between the tongue 6 and stop 12, a hydraulic or pneumatic damping element, or the like, for example. However, the vibration damper 13 is optionally (and as illustrated) a lip made of resilient material, in particular rubber or silicone, and fills the gap of the width a between the tongue 6 and stop 12 at least in the root region 9 of the tongue 6, such that a sandwich construction of tongue 6, lip 13, and stop 12 is produced there. This sandwich construction or this unit 6-13-12 can be assembled for example on a supporting part 15 of the keybed 3 by means of one or more common screws 14, bolts, etc. passing through the unit 6-13-12.

As can be seen from FIG. 2, each tongue 6 is in some embodiments trapezoidal as viewed from below or above, which assimilates the vibration behaviour of a struck string, and the lip 13 is optionally narrower than the tongue 6, such that the side edges 16 of the tongue 6 can vibrate freely. The lip 13, as shown in FIGS. 1 and 2, also ends clearly before the protruding end 10 of the tongue 6, more specifically before the region 17 of the tongue that is struck by the hammer head 4. The length of the lip 13 is for example half, two thirds, or three quarters the length of the tongue 6. The end of the lip 13 can also be rounded or tapered in a trapezoidal or triangular manner, as can be seen from FIG. 2. All of these measures contribute to the fact that the oscillation of the protruding end 10 and also the edges 16 of the tongue 6 can die away freely when the tongue is struck by the hammer 4, wherein the stop 12, in conjunction with the lip 13, limits and damps the maximum deflection of the tongue 6.

By adapting the length and breadth of the lip 13 and of the impact region 17 to the tongue 6, the impact behaviour of the key 2 in question and thus the response behaviour or feel of playing of the keyboard 1 can additionally be adjusted and in particular adapted to that of a classic grand piano or upright piano. In the case of an acoustic string, the impact is “harder” the shorter the string is and therefore the higher is the tone thereof is. This can be emulated in that the lip 13 of the tongue 6 of a key 2 that is associated with a higher tone of the musical instrument is longer than the lip 13 of the tongue 6 for a key 2 that is associated with a lower tone; and/or in that the tongue 6 for a keyboard 2 for a higher tone is shorter than the tongue 6 for a keyboard 2 for a lower tone; and/or in that the hammer head 4 of a keyboard 2 for a higher tone strikes the tongue 6 closer to the root 7 thereof than the hammer head 4 of a keyboard 2 for a lower tone. The breadth of a lip 13 can also be adjusted accordingly, for example it can be wider for a higher tone and narrower for a lower tone.

FIGS. 3a to 3c show an advantageous construction for the keyboard 1 by the combination of a plurality of tongues 6 in a common printed circuit board 11 as explained above (FIG. 3a); the combination of a plurality of lips 13 of adjacently arranged keys 2, the lips 13 being formed from a common sheet 18 of resilient material, protruding therefrom in a comb-like manner (FIG. 3b); and/or the combination of a plurality of stops 12 of adjacently arranged keys 2 in a common stop plate 19 (FIG. 3c). For example, a common sandwich unit formed of printed circuit board 11, forming the tongue sheet 18 forming the lip, and stop plate 19 can thus be produced for one or more octaves of keyboards 2. The keyboard 1 then comprises a plurality of such units 11-18-19, or a single unit 11-18-19 is used for the entire keyboard 1.

In addition, a hole 20 can be provided in the impact region 17 of a tongue 6, which hole is smaller than the impact face of the striking hammer head 4. The hole 20 enables air to escape quickly between the striking hammer head 4 and the tongue 6 and thus reduces the noise of the keyboard 1 when this is being played.

The application is not limited to the presented embodiments, but includes all variants, modifications and combinations that fall within the scope of the accompanying claims.

What is claimed is:

1. A keyboard for an electronic musical instrument, comprising a keybed with a multitude of keys supported therein and comprising a multitude of hammer heads supported on the keybed, which hammer heads can each be driven by a respective key by means of a mechanism, wherein, in the keybed, each hammer head is arranged opposite a resilient tongue which is fixed at its root so as to be struck by the hammer head when the key is actuated, and wherein the tongue is equipped with an impact sensor, wherein, on the side of the tongue facing away from the hammer head, a stop for the tongue is mounted on the keybed at a distance from the tongue, wherein a resilient vibration damper lies at least in the region of the root of the tongue between the tongue and the stop.

2. The keyboard according to claim 1, wherein the vibration damper is a lip made of resilient material.

3. The keyboard according to claim 2, wherein the tongue is approximately trapezoidal and the lip is narrower than the tongue.

4. The keyboard according to claim 2, wherein the lip, as considered from the root, ends before the region of the tongue that is provided for the striking of the hammer head.

5. The keyboard according to claim 2, wherein the lips of a plurality of keys arranged adjacently in the keybed are formed from a common sheet of resilient material, protruding therefrom in a comb-like manner.

6. The keyboard according to claim 2, wherein the lip of the tongue for a key that is associated with a higher tone of the musical instrument is longer than the lip of the tongue for a key that is associated with a lower tone of the musical instrument.

7. The keyboard according to claim 1, wherein the tongue for a key that is associated with a higher tone of the musical instrument is shorter than the tongue for a key that is associated with a lower tone of the musical instrument.

8. The keyboard according to claim 1, wherein the hammer head of a key that is associated with a higher tone of the musical instrument strikes its tongue closer to the root thereof than the hammer head of a key that is associated with a lower tone of the musical instrument.

9. The keyboard according to claim 1, wherein the tongues of a plurality of keys arranged adjacently in the keybed are formed from a common printed circuit board, protruding therefrom in a comb-like manner.

10. The keyboard according to claim 1, wherein the stop is a stop plate common to all tongues.

11. The keyboard according to claim 9, wherein the stop is a stop plate common to all tongues and wherein the printed circuit board is screwed to the stop plate in the region from which the tongues protrude, with the vibration damper arranged in-between.

12. The keyboard according to claim 9, wherein the stop is a stop plate common to all tongues and wherein the printed circuit board is bolted to the stop plate in the region from which the tongues protrude, with the vibration damper arranged in-between.

13. The keyboard according to claim 1, wherein the region of the tongue that is provided for the striking of the hammer head has a hole which is smaller than the impact face of the hammer head.

14. The keyboard according to claim 1, wherein the impact sensor, as is known per se, is constituted by at least one strain gauge applied to the tongue.

15. The keyboard according to claim 14, wherein the tongues of a plurality of keys arranged adjacently in the keybed are formed from a common printed circuit board, protruding therefrom in a comb-like manner and wherein the strain gauge is contacted by means of the printed circuit board.

16. The keyboard according to claim 2, wherein the vibration damper is a lip made of rubber.

17. The keyboard according to claim 2, wherein the vibration damper is a lip made of silicone.
